(19) United States
(12) Patent Application Publication
(10) Pub. No.: US 2009/0150402 A1
(43) Pub. Date: Jun. 11, 2009

(54) SECURITY CUSTOMIZATION SYSTEM AND METHOD

(76) Inventor: Eric C. Stelter, Pittsford, NY (US)

Correspondence Address: David A. Novais;Patent Legal Staff, Eastman Kodak Company, 343 State Street, Rochester, NY, 14650-2201, US

(21) Appl. No.: 11/953,230

(22) Filed: Dec. 10, 2007

(51) Int. Cl. G06F 17/00

(52) U.S. Cl. 707/10

(57) ABSTRACT

A method and system for generating security customization data that is stored in a database allowing the security feature to be transferred from the database to a local printer to be printed as a verifiable marking usable for security image identification without local intervention or knowledge. Database access is controlled using the one or more access codes in conjunction with a controller and database that are remote from the printer or has remote control so that only those with access to that portion of the database can make changes.

### FIELD OF THE INVENTION

The invention relates to printing and more particularly relates to a method and system for printing security customization data using an electrophotographic printer.

### BACKGROUND OF THE INVENTION

The susceptibility of printed documents to fraudulent alteration and items to illegal copying costs the industry billions of dollars each year. Industry is in need of a system and related method to quickly and accurately assesses the authenticity of an item or document and to make alteration more difficult. Many schemes exist for security printing. These generally fall into two categories, those that involve substrate manipulation and those that involve addition of image content. Examples of substrate manipulation include US20030211 299 A1 which describes a coating for a retroreflective document which renders the surface of the document receptive to toners and inks printed thereon while not substantially interfering with the retroreflective properties of the underlying substrate. Methods for fabricating the document are also provided. U.S. Pat. No. 5,888,622A provides a coated cellulose web product and coating composition which provides enhanced toner adhesion for documents printed using noncontact printing devices such as ion deposition printers. The toner adhesion enhanced coating cellulosic product and composition comprises a cellulosic web having first and second major surfaces with at least one of the major surfaces having coated thereon a layer of a polymeric toner receptor.

U.S. Pat. No. 6,086,708A details a method of making a document, such as a check or stock certificate, having enhanced security against counterfeiting. The document includes a strip of foil having a three dimensional light diffracting image thereon affixed to the document. The strip of foil may be affixed to the document before or after the background printing or face printing of the document is completed. In this manner, the light-diffracting strip may be printing on by the background and face printing of the document as desired.

Examples of methods that involve manipulation of image content or imaging materials include US20050282077A1, which describes a toner for printing documents that are difficult to chemically, or physically forge and that are readily easy to visually verify and methods of using and forming the toner are disclosed. The toner includes a colorant for printing an image on a surface of a document and a dye for forming a latent version of the image underneath a surface of a substrate. An image formed using the toner of the invention is readily verified by comparing the colorant-formed image and the dye-formed image. In addition, if a solvent is used in an attempt to alter the printed image on the substrate, the dye migrates or diffuses to indicate tampering with the document.

US20050142468A1 describes a method of printing documents, for example bank checks, with a pantograph. Documents printed as described may include a digitally variable pantograph and other enhancements. The invention is particularly useful for enhanced security documents and the production thereof US20050142469A1 describes a printing system, process and product with microprinting. Documents printed as described may include digitally variable microprint and other enhancements. The invention is particularly useful for enhanced security documents and the production thereof.

Printers can also use security features such as encodements and markings to provide features like those described. U.S. Pat. No. 5,758,216, which discloses a one-time use, protected item or security-enhanced item that bears external indicia of a special promotion and the enclosed item, in this case film, has a corresponding magnetic encodement. Other means of printing security features on packaging that correlate with an encodement on the item have been disclosed, including U.S. Pat. No. 5,726,737, which discloses photography systems, security-enhanced items, and protected items in which a one-time use protected item or security-enhanced item bears external indicia of a preferential subject matter; such as action shots, scenic shots, and close-ups; and the enclosed film has a corresponding magnetic encodement.

The nature of the security feature itself, that is, the media used and the change in that media, has varied greatly. Security features that are unchanged for a particular item type are generally provided as a permanent feature of the item, or item container, or both. For example, Kodak Type 135 film canisters have a pattern of electrically conductive and non-conductive patches. Security features for variable features must be provided in another manner. U.S. Pat. No. 4,678,300 teaches an security feature in the form of a scratch on the outside of a film container. In the ADVANCED PHOTO SYSTEM™, security features are exposed spots on film or recordings on a magnetic layer. U.S. Pat. No. 4,500,183 discloses storage of “flag data” and other information on a magnetic disk or portion of a item or on a random access semiconductor memory (“RAM”) contained in a film cassette. U.S. Pat. No. 5,036,344 discloses the use of a film-protected item having an “IC card” that includes semiconductor memory, a microcomputer, and the like. The card provides continuous access to the information. U.S. Pat. No. 5,765,042 teaches a one-time use protected item having a security-enhanced item identification number printed on the outside.

Despite these methods of security enhancement, forgery and manipulation is still a problem. There is a need for a central source of the security features that is controllable by those that are allowed access to these highly sensitive security features without compromising the security features themselves. It is further desirable to provide an improved method and system for handling separately accessible user, verifier, and producer data relating the items of interest as is described below.

### SUMMARY OF THE INVENTION

The present invention, in its broader aspects, provides a method and system for generating security customization data that is stored in a database such that the security feature can be transferred from the database to a local printer for printing as a verifiable marking usable for security image identification without local intervention or knowledge. Database access is controlled using the one or more access codes in conjunction with a controller and database that are remote from the printer or has remote control so that only those with owner access to that portion of the database can make changes. In the method, a user access code is generated that will allow the print engine to access the security portion of the printing instructions via the controller. This allows access to the security instructions that will initiate specific printing instructions that will produce, in conjunction to the normal, non-security printing portion, a verifiable security marking to be printed on the receiver without the intervention or knowledge of the printer operator. Verifier access codes are also implemented that will allow submission of data obtained from the printed receiver for verification of authenticity without revealing the verifiable security marking. Using this method and system a variety of security features can be realized and the security attributes are hidden from those that are not owners of that security feature.

### BRIEF DESCRIPTION OF THE DRAWINGS

FIG. 1 is diagrammatical view of an embodiment of a system of the invention.

FIG. 2 is a diagrammatical view of an embodiment of a method for handling printing customization data.

FIGS. 3a-3d are diagrammatical views of an embodiment of the system of FIG. 1 being used.

FIG. 4 is a diagrammatical view of an embodiment of the input device of the system of FIG. 1.

### DETAILED DESCRIPTION OF THE INVENTION

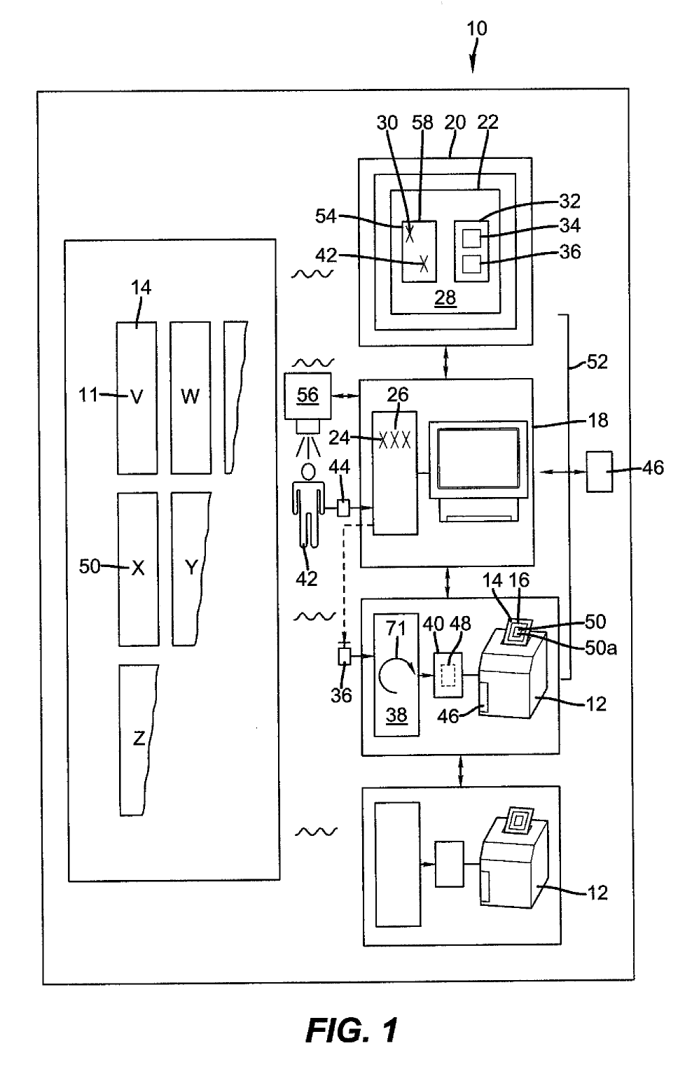

Referring to FIG. 1, a security customization system 10 includes a plurality of security-enhancing printers 12 to security protect individual items or units, hereafter referred to as receivers 14. The security customization system 10 can be regular printers that are used for printing verifiable security marking 50 containing customized security features 16. The system includes a controller 18 to control access to a remote database 20 having database memory 22 through the use of owner-controlled access controls, such as access codes 24 for verifying authorized users and remote equipment (controller ID) 26. Access codes for owners, users, and verifiers allow different operations to be performed, as will be discussed below. The database memory 22 stores a logical record 28 including one or more receiver ID records 30 and security instructions 32 comprising receiver specific instructions 34 and marking information instructions 36. A processor 38 generates marking information 40 from stored marking information instructions 36 for printing. The controller 18 may be geographically remote or access-wise remote from the printer so that only a rightful owner 42 of security data 44 has control over and knowledge of the security instructions 32 that are accessed by the user or by the print engine and communicated to processor 38. The security instructions 32 can be generated by a separate controller 46 including one in the printer or another source or electronic device such as a cell phone or personal assistant controller (PDA).

The one or more printers 12 are in communication with the database memory 22 and the processor 38 and controller 18 to enable the local printer 12 to print a processed security marking 48 derived from the security instructions 32 transferred from the database 18 under control of the owners through user access controls in the controller to the processor which processes the security instructions 32 using all the information available, including receiver ID records 30 and local conditions such as the identities of processor 38 and printers 12 as well as the normal printing instructions 40 to produce a verifiable security marking 50 usable for security image identification 16 on the receiver 14. The controller 18 using the access codes 24 controls the approval process and the communication of the security instructions occurs via a communication network 52 for transferring the marking information instructions from the remote database 18 to the printer 12. The verifiable security marking 50 can include previously printed information on the receiver 14 in combination with the processed security marking 48 to form the security image information 16.

The one or more security databases 20 are part of the communication network 52 or in communication with one or more controllers, sometimes referred to as computing devices, 18 and contain one or more look-up tables (LUT) 54, as well as transmission and control units such as one or more input devices 56. The LUT 54 is provided as a portion of memory 22 in one or more computing devices 18. The LUT 54 holds data related to security protected individual items or units including the logical records 28. The LUT 54 is accessible via the input device 56.

Remotely accessing and changing the data in the respective logical record 28 allows for customization of the security-enhanced receiver 14. The customization includes modifying some portion of the security-enhanced receiver 14 to change the resulting security-enhanced receiver 14. The customization can add, remove, or change one or more features to provide a wide variety of different combinations. The security-enhanced receiver 14 can be modified indirectly, since the customized features are only manifest after printing, or the receiver 14 can be directly modified, such as by changing its shape by notching or punching, changing its chemical composition, or by making an optical or magnetic recording on receiver 14 The term “security-enhanced receiver” is used herein to refer to an item, a label, or other printed media, as well as packaging products, and any identifying features that it may contain, including magnetic layers or semiconductor chips. Image data used in the customization can be stored for archival purposes, with or without media modification, and data for physically associated features supporting use of the media can also be stored. The database can store a plurality of archival images to be used in security customization along with algorithms, chemical information, and other related identification methods that will be discussed in more detail below.

The invention is generally discussed herein in terms of security enhancing printers 12 that are electrophotographic printers. It will be understood that equivalent considerations apply to other types of printers or other devices that can be used to modify the receiver. The database is also generally discussed herein in terms of the memory being used for both capture and storage of archival image information and security algorithms and related security identification components, such as chemical identifiers. It should be understood that stored images might, in some cases, be modified or added to one another in effective layers and mixed with other security markings produced by the algorithms, chemicals, optical components such as holograms or embedded marking components as well as other components of the security marking to be printed or applied to the receiver 14.

The security-enhanced features may be added to during transmission from production to wholesale to retail and on to the customer. For example, a security-enhanced receiver 14 can start out with the verifiable security marking 50 or indicia of the producer and then the wholesaler may add an additional security marking 50a or enhance and/or modify the current security marking 50. This security-enhanced receiver 14 can then compared to what the database states should be present by using the input device 56. The stored security-enhanced features are generally treated herein as being additive. It will be understood that this is a simplification provided as a matter of convenience for explanatory purposes and that stored features will differ in reality in manners well known to those of skill in the art. For example, the stored features are subject to enhancement modification between production and sale. Each security-enhanced receiver 14 bears its unique verifiable security marking 50 associated with a receiver ID 58 stored in the receiver ID record 30 at each step (represented in FIG. 1 by the letters “X”, “Y”, and “Z”). The receiver ID 58 is used to locate the logical record 28 associated with a particular security-enhanced receiver 14 having the verifiable security marking 50.

The verifiable security marking 50 can be an image, a tag, such as a chemical tag, or indicia, such as a number or other alphanumeric or non-alphanumeric sequence or arrangement, which may or may not be human readable or machine-readable using a standardized security scheme, such as a standard one- or two-dimensional bar code or chemically analysis. One particular embodiment of the verifiable security marking 50 includes a specific sequence or arrangement and its cognates. A cognate is a product of a mathematical function, such as an encryption or decryption function, or other translation, applied to the sequence or arrangement. The security-enhanced receiver 14 may bear multiple copies of a sequence or arrangement and any cognates. The term “verifiable security marking 50” is inclusive of such multiple copies, each verifiable security marking 50 can be printed so that each can be identified, without necessarily reading each copy of multiple copies.

The verifiable security marking 50 can be recorded on the exterior of the security-enhanced receiver 14 in human-readable form or publicly available, standardized-machine readable form and can have multiple parts with one part recorded in one form and another part recorded in another form. It is convenient that the security-enhanced receiver 14 have an easily readable designation (also referred to herein as a “label number”) on the exterior that can be used in the way serial numbers are used now, for example, to relate an item 14, such as a product label, to a database or LUT 54. The label number can be also used, when modified as discussed here within, as the verifiable security marking 50. This is convenient if the input device 56, discussed in detail below, requires the user to key in the access codes 24. With a one-time protected item 14, the item 14 carries the verifiable security marking 50, and also any related components within the item 14 may also carry the verifiable security marking 50. It is highly preferred that the security instructions for each receiver ID record discussed herein be fully unique, that is, each verifiable security marking 50 is not repeated and each verifiable security marking 50 is limited to a single security-enhanced receiver 14 and a single associated logical record 28. Unique receiver ID records can be readily provided by use of non-repeating sequences of numbers or codes. If different producers are likely to use the same numbers, then it is also desirable that producer identification also be included in the receiver ID record 30 to ensure uniqueness.

It is preferred that the verifiable security marking 50 be recorded in conjunction and contemporarily with the printing of any normal image and/or indicia printing information processed locally, to enhance security and reduce the risk of damage to the security-enhanced receiver 14 or loss of captured image information or carrying capacity of the security-enhanced receiver 14 when the verifiable security marking 50 is read. Alternately the verifiable security marking 50 can be printed separately from the printing of local data to allow for alternate handling procedures. For example, printing the verifiable security marking 50 on the exterior of the item 40 after printing would be an alternate method of providing the verifiable security marking 50. Printing multiple verifiable security markings 50 on the item 14 can enhance security and better assure the authenticity of the product.

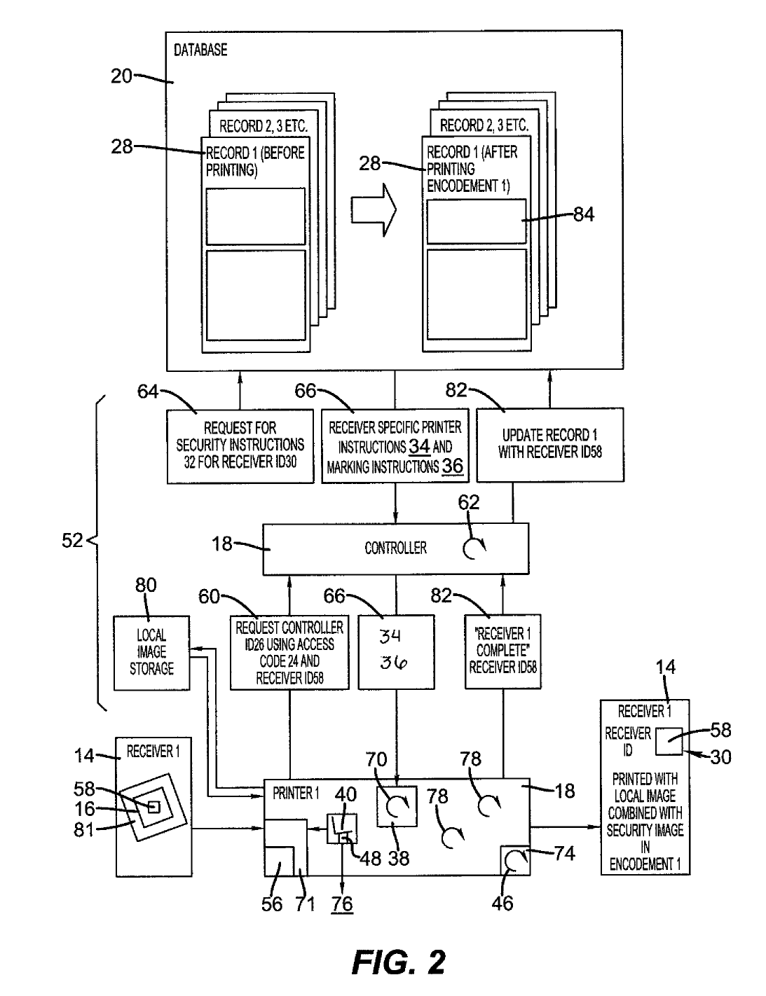

A related method for the security customization system 10 shown in FIG. 2 generates the security customization data that is stored in the database 20 as well as transfer information from the database 20 to a local printer to be printed as a verifiable marking usable for security image identification using the communication network 52 and a user access code. Database access is also controlled using the one or more owner access codes 24 so that only those with access to that portion of the database 20 can make changes. The system allows digital variably controlled changes to the receiver 14 during said generating, transferring and printing steps. The systems, methods, and apparatus disclosed herein all have common features and specific embodiments can each include some or all of the features discussed herein, except where, as will be apparent from the specification, specific features cannot be combined. Reference should thus be made to the figures generally in relation to each embodiment.

The security customization system 10 method shown in FIG. 2 starts by requesting 60 secure information from a controller 18. A verification step 62 verifies one or more controller IDs 26 in the controller 18 using the user access codes 24 and other applicable data such as receiver type and printer ID to request 64 access to the remote database 54 via the controller using the receiver D 30 to access one or more logical records 28 containing security instructions 32 corresponding to one or more receivers 14. The security instructions 32 include receiver specific printing instructions 34 and marking information instruction 36 for generating marking information 40. The marking information instructions 36 are transferred 66 to the processor 38, shown here as coincident with the printer but which could also be a separate processor or could be part of the printer 12 to generate 70 actual confirmed marking information 40 that is verified 74 by separate processor 46 as the actual confirmed marking information 40 containing the processed security marking 48 and transmitted 76 to the printer 12 via the controller. The actual confirmed marking information 40 is used by the printer 12 to print 78 the marking information as a verifiable security marking 50, in conjunction with any local print data 80 transmitted to the printer 12.

The verifiable security marking 50 usable for security image identification 16 on the receiver 14 is created in a manner that has controlled access and using receiver specific printing instructions 34 and marking instructions 36 that are not local to the printer. The resultant information that indicates the printing was completed is used to update 82 the logical record 28 to form an updated 84 logical record 28. The verifiable security marking 50 can contain local image data 80 and preprinted image data 81 on receiver 14 and can also contain receiver ID 58. For a newly created receiver, the receiver ID 58 or serial number can either be downloaded from database 20, or generated by local processor 46 and uploaded to the database 20 during update step 82. For a receiver that has been created previously, the receiver ID 58 can be read by input device 56.

The security customization system 10 method, in one embodiment, enables the printer 12 to request the marking information for the receiver 14 via user access codes to the controller 18. The generating step 70 further includes digitally generating information during said generating 70, transferring 76 and printing 78 steps that will be used to update 82 the logical unit 28. The image can be printed on an existing image or printed as part of the modified image. The security instructions 32 can include an encryption key 90 to unlock encryption on the system to make the marking information 40. The marking instructions in one embodiment are multi-part so that the marking instructions for each process step are separately stored and separately readable at each step of the process, and for each process step, are readable to only those with user access to said encryption key 90 by the controlling owner for that process step. The verification 62 further includes the state of the receiver 14 and which process step and location the receiver is at, such as at manufacturing, wholesale, retail, customs, and security check point so that the customized security markings can be customized for each location.

The term “look-up table” refers to both a complement of logical memory in one or more computing devices 18 and to necessary equipment and software for controlling and providing access to the logical memory. The term “logical record” refers to a portion of the logical memory allocated to an individual security-enhanced receiver 14 and is inclusive of hardware and software in the same manner as “look-up table”.

The records 30 are used in the database, which in one embodiment uses the LUT 54, but could take other storage formats as one skilled in the art would understand, to identify corresponding logical records 28. The relationship between an verifiable security marking 50 and the associated logical record 28 in the LUT 54 can be direct; for example, the logical record 28 can bear, in compressed or uncompressed digital form, the verifiable security marking 50 for the associated security-enhanced receiver 14, or the verifiable security marking 50 can be a pointer to an address for the logical record 28. The relationship between the verifiable security marking 50 and associated logical record 28 can be indirect. The verifiable security marking 50 can be distinguished by the structure of a database 20 or by a memory address path, or the relationship between parts of the verifiable security marking 50 and a logical record 28 can be distributed. For example, a logical record 28 could have the numeral three to identify a particular hard disk array, 6 to identify a hard disk, 9 to identify a logical array, data structure or file, and so on. As another example, the verifiable security marking 50 can point to a database element, which can point to an element in another database, and so on. In a particular embodiment, the LUT 54 is structured to associate sequential records with sequential table elements. These approaches can be combined and individual elements can be in the same physical component or multiple components in diverse locations can used by means of one or more networks.

The allocation of the logical record 28 can be limited to setting aside enough available memory to accommodate data for the security-enhanced receiver 14. The memory set aside does not have to initially include any information about the security-enhanced receiver 14. It is preferred, however, that the logical records 28 be allocated by creating the logical records 28 in the form of individual files or entries. It is further preferred that the security instructions 32 be written to the logical records 28 for the respective security-enhanced items or that the LUT 54 be structured to indicate the security instructions 32 for the respective logical records 28, when the logical records 28 are allocated. The security instructions 32 can be written or the LUT 54 be restructured later, when needed; but this is less controllable and thus likely to increase the risk of erroneous entries or misallocations. The writing of security instructions 32 during allocation of logical records 28 also ensures that every security-enhanced receiver 14 has, at all times, some security instructions 32 in the LUT 54. The verifiable security marking 50 on a security-enhanced receiver 14 can be compared with the security instructions 32 in the LUT 54 to determine if there is an irregularity, such as a misreading of the verifiable security marking 50 due to damage to the security-enhanced receiver 14. It is convenient if the logical record 28 is associated with the respective security-enhanced items in lock step with the recording of the verifiable security marking 50 on the security-enhanced receiver 14. This assures that involved logical records 28 can be easily identified when there is a breakdown in allocating or verifiable security marking 50 printing or the like.

The memory allocations for individual security-enhanced items can be created at the same time or before those security-enhanced item s are made or creation of the respective logical records 28 can be delayed up until the time that the security-enhanced items are first customized. Logical records 28 can be provided as portions of physical memory of fixed size, but this is wasteful of resources. Many security-enhanced items are unlikely to be customized and thus much space in memory allocations would never be used. It is preferable to adjust the size of logical records 28 as needed. Many computer operating systems include a file system, such as a file-allocation-table that adjusts file sizes in this manner. The LUT 54 can utilize such an operating system and provide each memory allocation as a separate file. This approach is workable, but is non-optimal in terms of access time, memory usage, and security. It is preferred that the memory allocations be handled by database management software. Access to the database can be provided by the database management system or through a generalized query language such as SQL (Structured Query Language).

The logical records 28 are maintained for a set time or indefinitely. Limiting the scope of recorded marking instructions 36 to deviations from default values can reduce space required for the logical records 28 in the database. In other words, the absence of an entry in the logical record 28 for a particular processing parameter signifies a default value for that parameter. With a large number of security enhancing printers 12, the space saved is likely to be very great, since many security-enhanced items will never be customized and many will remain at default values.

The database is remote from the security-enhanced items during the use of the security enhancing printers 12. Thus, the physical components of the database are not portable with the security enhancing printers 12. The database can be directly connected to, or a part of, one of the printing units 12; but it is preferred that the database is also remote from the printing units 12. The database is preferably a networked computer or system of computing and information storage devices. For simplicity, the database is generally referred to herein as a single networked computer.

Remote access to the database is provided for the security enhancing printers 12, by means of input devices 56. The printing units 54 can also remotely access the database. The input device 56 and security-enhanced receiver 14, can write to, and preferably read from, a respective logical record 28. The interface and method of communication between the input device 56 and the LUT 54 is not critical. For example, the input device 56 can incorporate and communicate via a dial-up modem or can communicate using a dedicated communication link or the Internet. The input device 56 could operate the LUT 54 by remote control, but for reasons of security and convenience, it is highly preferred that the input device 56 act as a networked remote node. Communication can be one-way (half duplex) or two-way (full duplex) from the input device 56 to the LUT 54 and can immediately change the LUT 54 or change the table on a delayed basis. One-way communication presents a risk of errors due to communications problems, equipment breakdowns and the like. Delayed communication can resolve errors, but then requires multiple accesses for a single customization. It is highly preferred that communication be two-way and that all entries in the input device 56 be immediately confirmed as being received and entered by the LUT 54.

The controller 18 receives marking instructions 36 from the LUT 54. The controller 18 controls the printers 12 in accordance with the marking instructions 36 to process the security-enhanced receiver 14. The terms “process” and “processing” and like terms used herein, refer broadly to the preparation of prints or other viewable images from film images or digital images, and are inclusive of printing, unless the context indicates otherwise. The term “marking instructions” used herein, refers to values for selectable aspects of processing or printing a receiver. One example of marking instructions includes a printing parameter. The “printing parameter” is an element of data, such as a binary number; a list; a data structure; a record; or a software object, such as a unit of software, a text file, or an image. A printing parameter can itself contain information or can be a pointer to a source of information available elsewhere; for example, in the same computer or through a network, such as the Internet. Specific parameters available and their values are dependent upon the capabilities of the equipment and software used for processing.

Marking instructions 36 can even control the operation of the printer 12, preferably by changing settings on automated equipment. Marking instructions 36 can be used to signal requests for procedures requiring human intervention, but this is undesirable unless used for exceptional procedures, since it adds continuing costs and the risk of human error. The particular marking instructions 36 customizable and available customizations are functions of the printer used and can include an almost unlimited variety of customizable options in addition to the digital image modifications applied to captured images as a part of ordinary processing, such as digital inversion of colors as a part of digital printing. These options can be roughly divided into two categories: remedial efforts and alterations. Remedial efforts are directed towards retaining the original information content, but improving the perceived quality of an image. Alterations deliberately modify some of the original information content of an image.

FIG. 2 shows one embodiment of the printing security system 10 used to customize the data to be printed, including the security data, using the input devices 56 and the database 20 to access and change the data in respective logical records 28 before, during and after printing receiver 14. The input device 56 in a station 71 (shown here as part of printer 18) communicates the state of the security customization of receiver 14 and the receiver ID 58 to the database to generate the respective security instructions 32, which is ultimately communicated to the printer 12 The input device 56 can be limited to a terminal including a controller 18 having a microprocessor or the like having a display and a keyboard or other input means as shown in FIG. 1. The station 71 to receive the security-enhanced receiver 14 and a detector 56 disposed in the station 71 are used to read the existing security information 16 including the receiver ID 58 from the security-enhanced receiver 14. This helps ensure that the new verifiable marking 50 is printed on the correct security-enhanced receiver 14. Information can be manually fed into the input device 56 or can be provided by accessing reader or a portable information storage device such as a smart card. In the latter case, the input device 56 must have an appropriate interface for the storage device. The user can also provide information by inputting a user identification number or the like to access the database 18 and provide receiver ID 58 and security information 16. The database can be in direct or indirect or remote communication with the input device 56. The information provided by the system owner to facilitate identification can be limited to user identification number or can also include printer ID, receiver ID, or other portions of security information 16. The input device 56 can be a single purpose device or can be an appropriately configured personal computer and peripherals. The details of the station 71 and detector 56 depend upon the manner in which the verifiable security marking 50 is recorded. For example, if the verifiable security marking 50 provided is visible on the receiver, such as a visible bar code then the detector 56 can be a hand-held bar code reader and the remainder of the station 71 can be a support surface, preferably configured to dock the security-enhanced receiver 14, that is to receive and hold the security-enhanced receiver 14 in position.

### Logical Record

The logical record 28 for a particular security-enhanced receiver 14 can be allocated or modified at any stage in the printing or handling of the receiver 14. The allocation can be limited to setting aside a range of memory, but preferably also includes setting up individual logical records 28 for each security-enhanced receiver 14 and associating identifiers 42 with respective security enhancing printers 12 by either recording identifiers 42 in respective logical records 28 or structuring the table to indicate the association between identifiers 42 and their logical records 28. The logical record 28 for a particular security-enhanced receiver 14 can also be modified and/or updated after printing by another if that representative has appropriate access to the additional printing step. Such a representative could include a producer, a distributor or a reseller (hereafter referred to collectively as “local owners”). Security-enhanced item customization, that is, the writing of changes in marking instructions 36 to the LUT 54, can occur in the hands of one or more of the local owners, who are also users if they print verifiable security marking 50 on receiver 14. Like “local owner”, “user” is used herein as a collective term. Absent limitations discussed below, the holder of the security-enhanced receiver 14 can customize the security-enhanced receiver 14 at any point if the holder is a user. If the holder is a local owner, the holder can make changes in the marking instructions 36.

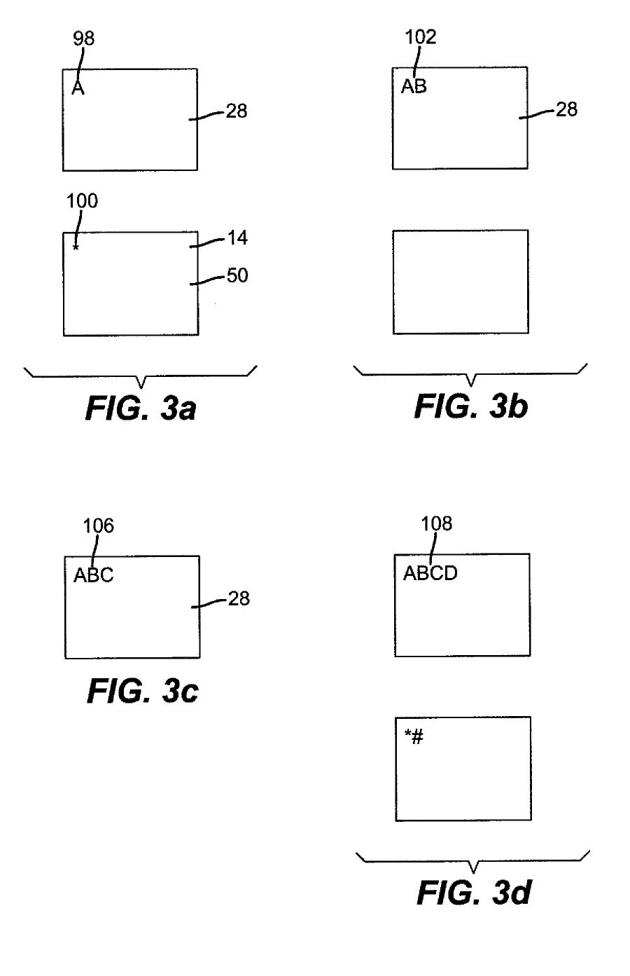

The security-enhanced receiver 14 is first customized during printing. This is illustrated in FIG. 3a as the addition of the printing parameter “A” 98 to the logical record 28 for the security-enhanced receiver 14. The verifiable security marking 50 bears an indicia 100, illustrated by a large number “1”, which communicates the customization by the first local owner to a subsequent local owner or to a verifier. This indicia can contain the receiver ID 58 in human readable or machine readable form. If desired, customization information 50 can be written to a security-enhanced receiver 14 exterior, or applied as an addendum during any customization. The security-enhanced receiver 14 is then sold or moved to a second local owner and the logical record is updated by the first local owner. This is illustrated in FIGS. 3a-3b as the addition of the printing parameter “B” 102 to the logical record 28 for the security-enhanced receiver 14. The security-enhanced receiver 14 is again customized when received by the second local owner. This is illustrated in FIGS. 3b-3c as an addition of the printing parameter “C” 106 to the logical record 28. The input unit 56 reads the verifiable security marking 50 on the security-enhanced receiver 14 and, with a user access code, communicates with the LUT 54 to determine the marking instructions 36 for the security-enhanced receiver 14. The LUT 54 reports (retrieves) the marking instructions 36 and the receiver is processed in accordance with those parameters. The printing unit 18 customizes the security-enhanced receiver 14 by addition of the numeral “2”. This is illustrated in FIGS. 3c-3d and includes the addition of the printing parameter “D” 108 to the logical record 28 for the security-enhanced receiver 14.

The parameters 98, 102, 106 and 108 can be related to particular procedures to provide a detailed history of the receiver. Referring to FIGS. 3a-3d, the first customization is by the producer of the packaging and printing parameter “A” 98 can designate a factory and production date or time. The next customization is by the producer of the packaging and printing parameter “B” 102 designates ship date or intended receiver. The next customization is by the packager and may indicate a particular factory or receipt data. The printing parameter “C” 106 is added to indicate that the security-enhanced receiver 14 has been received. The next customization is again by the packager. The printing parameter “D” indicates production run, or item serial number and that the package has been filled. The indicia 2 can contain coded information corresponding to printing parameters A B C and D. It will be apparent from this example that the marking instructions 36 can relate to any printing services for a particular security-enhanced receiver 14. Other services or products unrelated to printing of that security-enhanced receiver 14 could also be provided, but this would likely be of limited utility unless the services or products had some relationship to the images captured in the security-enhanced receiver 14.

FIGS. 3a-3d figuratively illustrate an embodiment of the method for pharmaceuticals. At a printing factory, the packaging is printed and encoded with origination information obtained from the database controlled by the owner and accessed by the user. The logical record is updated with origination and destination information. Upon receipt at the next processor, which in this case is the packager, the logical record is updated with receipt information. During packaging, the logical record is updated with human-readable serial number or batch information as well as encoded information containing the origination, receipt, batch, and destination information. The printed package is updated with human-readable and encoded information. For verification, the verifier scans or reads the encoded information and submits the human-readable serial number or other information to the database using a verifier code to access the corresponding logical record. The presence and accuracy of the submitted encoded information with additional information, such as the verifier's location, indicates authenticity. The controller indicates to the verifier if the item is authentic or not authentic. Additionally, for a pharmaceutical, packaging inside the bottle can be encoded, or each pill can be encoded with a batch number in human-readable or machine readable form. There are other uses for the encoded information, such as verification of narcotic drug handling compliance with government guidelines. For some receivers, the security information 16 containing the verifiable security marking 50 is damaged or missing. The verifiable security marking 50 may be unreadable or spurious due to error, or damage, or deliberate counterfeiting. The verifiable security marking 50 can indicate one variety of a product or indicate another variety of the product. If the security information 16 does not match the data in the record 28 associated with receiver ID 58, the process is stopped and the owner or local owner is notified.

The security enhanced receivers are checked by verifiers, who may also be local owners or users, by using the input device 56 for the presence of a readable verifiable security marking 50. The reader 56 is directed at the security enhanced receivers 14 and the verifiable security marking 50 is read, or found unreadable. It is highly preferred that this step is automated, thus it is also preferred that the security enhanced receivers 14 are standardized in shape and position of verifiable security marking 50 to ensure easy and accurate reading of the security information 58. If the verifiable security marking 50 of a particular security-enhanced receiver 14 is found to be unreadable, then that security-enhanced receiver 14 is culled. The culled security-enhanced receiver 14 is then subject to special handling. For example, the owner can be notified and the security-enhanced receiver 14 can be processed individually or returned to the submitter or a new verifiable security marking 50 can be placed on the security-enhanced receiver 14 by the local owner and the security-enhanced receiver 14 can then be resubmitted to the entry station 71. An verifiable security marking 50 is unreadable if no verifiable security marking 50 information can be obtained or if the information is noticeably incorrect in some way. For example, a verifiable security marking 50 can include a checksum or other error checking code, which would render a verifiable security marking 50 unreadable, if incorrect.

After receiving security identification information 16 from the verifiable security marking 50, the controller 18 accesses the LUT 54 and polls the LUT 54 to determine if the verifiable security marking 50 is listed. If the verifiable security marking 50 is unlisted or otherwise unidentified, the security-enhanced receiver 14 is culled and handled separately as previously described. The printing unit 18 receives 66 from the LUT 54 a report of printing parameters 34 and 36 for each security-enhanced receiver 14 having a listed verifiable security marking 50 and processes the security-enhanced receiver 14 in accordance with the respective printing parameters 34 and 36. The printing parameters can then be changed 82 in the look-up table to indicate that the receiver was processed and, if desired, record other information about the processing. The process can be repeated for additional printing of the same security-enhanced item. Marking instructions 36 can be obtained from the LUT 54 as needed immediately before processing of a security-enhanced receiver 14 or can be earlier obtained and then stored within the controller 18 of the printing unit 54 until needed.

Processing will vary depending upon the marking instructions 36. For digital security enhancing printers 18 the marking instructions 36 will indicate that current printing depends on the previous state of the receiver. When a security-enhanced receiver 14 is first printed a change can be written to the marking instructions 36 in the respective logical record 28 of the LUT 54 to indicate that the receiver was printed. Other changes can be written to record characteristics of the processing, as desired. The marking instructions 36 can include parameters that control sorting equipment to sort the security enhanced receivers 14 to different processes and set up parameters for automated equipment to provide those processes. Marking instructions 36 for printing can include digital alteration of images, selecting of media or addendum, selection of particular promotions, and the like. Table 1 lists some examples of categories of marking instructions 36.

TABLE 1

| General | Security | Physical |
|---|---|---|
| Printing | Printing | Modification |
| 4 color image | Invisible ink | Notching |
| Spot color | Metameric ink | Chemically |
| | | reactive ink |
| Overcoat | Modifications | Magnetic |
| | to halftone | recording |
| | screen: | |
| | embedded | |
| | security image | |
| Laminating | Traceless | Optical |
| | printing | recording |
| | Microprinting | Digitally |
| | | Recordable |
| | | RFID |
| | Registration | Folding and |
| | of security | gluing |
| | image with | |
| | other image | |
| | features | |

The LUT 54 contains important information that should not be subject to a risk of easy accidental or malicious damage. A measure of security can be provided by use of an access codes 24 that must be submitted for access to the logical record 28 for the security-enhanced receiver 14 having that serial number. The access code 24 can be a part of the verifiable security marking 50 or can be supplemental to the verifiable security marking 50. (Access codes 24 in the form of encrypted cognates of a human readable label number are discussed below.) The access code 24 is recorded in the respective logical record 28 or is instead recorded in a gatekeeper, a physical or logical part of the LUT 54, which limits access to the logical records 28. For access to be granted to a particular logical record 28, both the verifiable security marking 50 and the access code 24 must be submitted and matched. The use of the access code 24 protects against misuse of the LUT 54. Incorrect access codes 24 submitted with correct identifiers 58 likewise block access. To be useful, the access code 24 needs to be somewhat individual to a particular security-enhanced receiver 14 and available to the holder of the protected item when customization is desired.

### Access Code Details

Referring now particularly to FIGS. 1 and 2, the identification 58 for a particular logical record 28 is transferred along with the respective security-enhanced receiver. The logical record 28 has an access right that is secured by the access code 24 and the appropriate printer ID, owner, local owner, user, or verifier ID. The manner in which the access code provides security can vary. For example, with a logical record 28 that is a separate computer file, the access code can be a password that must be supplied before reading or writing or otherwise accessing that file in some manner. The access right can be limited to reading only, or limited in some other manner; but for a local owner preferably includes rights to repeatably read from and write limited information to the logical record 28, as shown in FIG. 3. The user of the security-enhanced receiver 14 only has control of downloading the corresponding printing parameter choices provided by the logical record 28. The verifier can only upload security information 16 and receive authentication.

Referring specifically to FIG. 1, the owner initializes the system. The security-enhanced receiver 14 is prepared, receiver IDs 58 are generated, and access codes are generated for the local owners, users, and verifiers of each process step. A logical record 28 having access rights secured by the access codes is allocated to the security-enhanced item. This allocation can use an identifier 58 in the manner above described. The identifier 58 is recorded for inclusion with the security-enhanced item or generated, printed, and stored in the logical record 28. This identifier 58 can be on the security-enhanced item, packaging for the security-enhanced item, a slip of paper or other addenda, or in some other manner that provides access to the user of the security-enhanced item; but otherwise maintains secrecy. The security-enhanced receiver 14 is sold or otherwise transferred. Printing parameters can be posted to the logical record before or after handling, or both. The verifier access code can be transferred with the security-enhanced item. It is highly preferred that the access codes be activated to enable processing of each security enhanced receiver by the next local owner or user only after transfer and that read or write access rights controlled by the access code not be retained by the local owner or user after transfer of the security-enhanced item.

To prevent inadvertent disassociation of the receiver ID 58 and security-enhanced receiver 14, it is preferred that the receiver ID 58 is recorded on the security-enhanced receiver 14. The receiver ID 58 can be a series of alphanumeric characters that is keyed in when the LUT 54 is accessed. The receiver ID 58, in this case, can be recorded on the security-enhanced receiver 14 in the same manner as the verifiable security marking 50.

The receiver ID 58 and verifiable security marking 50 can both be recorded on the security-enhanced receiver 14 or on a container for the security-enhanced receiver 14 in human and machine-readable form. The receiver ID 58 can be recorded on the security-enhanced receiver 14 in a non-public machine-readable form. The verifiable security marking 50 that is part of the security image information 16 is preferably also machine-readable. It is convenient if the verifiable security marking 50 is also human readable.

### Detection

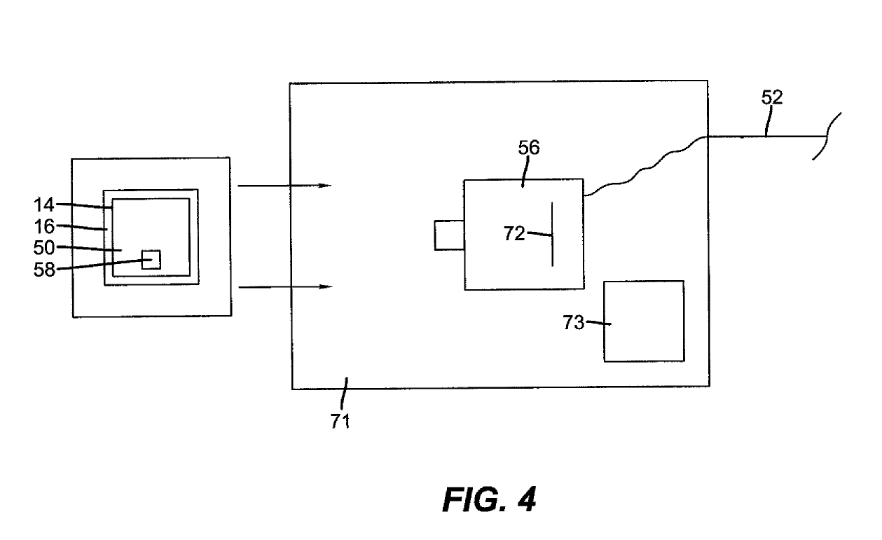

Reading security image information 16 requires the use of an entry station 71 containing an input device 56 having a suitable detector 72 shown in FIG. 4 The entry station 71 may also contain a keypad 73 or other device to input the verifier access code. As mentioned previously, it may contain a computer. It is also preferred that the security image information 16, which preferably contains receiver ID 58, is embedded in the security-enhanced receiver 14, that is, recorded in a manner that is not alterable without damage to the security-enhanced receiver 14. For example, embedded security image information 16 can be provided in a non-alterable magnetic stripe on the exterior of the security-enhanced receiver 14 in the same manner that magnetic stripes are commonly provided on credit cards. Embedded security image information 16 can similarly be provided in an electronic memory component or other local data memory attached to the exterior of the security-enhanced receiver 14 or mounted in the interior of the security-enhanced receiver 14 and accessible wirelessly or through electrical connections. The input device 56 can be mounted on entry station 71 and connected to communication network 52. Verification can be communicated from the controller 62 to the verifier or to the printer 18 and local owner through the communication network.

The receiver ID 58 for a particular security-enhanced receiver 14 can be generated before or after allocation of a logical record 28 to the security-enhanced receiver 14. It is preferred that receiver ID 58 be generated and recorded in the security-enhanced receiver 14 during printing of the security-enhanced receiver 14. It is also preferred that receiver ID 58 be generated and logical records 28 be allocated before the creation of the security-enhanced receiver 14.

The label number, access code, and public identifying information can all be fully discrete from each other. Alternatively, a single alphanumeric string or the like, can act as label number, identifier, and access code. Intermediate states are likewise both possible and practical. For the purposes of explanation, in the figures, the access code is generally separate from the public identifying information and the label number is also separate.

The access code 24 can have two segments or parts, one of which is an encryption of the other. The verifiable security marking 50 of the security-enhanced receiver 14 can include one or both of the segments. The LUT 54 only grants the user or other holder of the security-enhanced receiver 14 access to the remotely stored data in the LUT 54 if a code value obtained by decrypting a submitted first segment, matches a second segment. In accessing the LUT 54, the security-enhanced receiver 14 is registered and the encrypted first segment of the access code 24 is detected. The registering preferably includes docking the security-enhanced receiver 14 in an input device 56 and reading the first segment, for reading the verifiable security marking 50. The maintained key is then accessed 60. The first segment is then decrypted and matched to the second segment. If a match is found, then access to the logical record 28 for the respective security-enhanced receiver 14 is allowed. If no match is found then access is denied.

### Duplication

In the system of FIG. 1, the entry for each security-enhanced receiver 14 in the LUT 54 includes the verifiable security marking 50 and no additional information or one or more changes from default marking instructions 36. In an alternative system having the look-up table separated into subunits, each logical record 28 in the LUT 54 includes two or more subunits, each having a different class of information. The subunits can be logical or physical partitions and can be differentiated from each other in the same manner as the logical records 28. Separate user subunits are convenient, but any number of subunits can be provided for any purpose, including each piece of processing or printing equipment. For convenience, this system and method is generally discussed herein in terms of the user subunit, but it will be understood that these terms are descriptive, but not limiting. For multiple copies of having the same receiver ID number 58, counters can be placed in each subunit in the logical record 28 corresponding to receiver 58 and updated as each local owner, user, or verifier processes the receiver.

### Origination of Whole Thing

Referring to FIGS. 1-3, to initialize the security customization system 10, the owner of the security customization system 10 generates a receiver ID number and a logical record 28 for each security-enhanced receiver 14, or for a number of identical security-enhanced receivers. Local owner, user and verifier access codes are generated, and ID's are generated for each local owner, user, and verifier or printer. A logical record, preferably having local owner, user and verifier subunits is allocated to the security-enhanced item, with counters if the security enhanced receivers are not tracked individually. Printing parameters are designated as previously described herein. The expected security image identification 16 and user or controller identification codes for each step requiring verification are stored in the corresponding step in each subunit of the logical record. Preferably, a verifier code is transferred with the security-enhanced receiver. The logical record is maintained throughout this process and the local owner can post changes in parameters to the logical record after access is achieved using the access code and other identifying information. Information provided during each verification step is compared to the expected information.

### Tracking

The system can be used to track status data for a security-enhanced item. For example, as shown in FIG. 3, the logical record 28 in the look-up table can contain information that relates to the distribution and usage of the security-enhanced item. The security-enhanced item is printed and a logical record is allocated to the security-enhanced item. Initial status data is written A to the logical record. This data is likely to include date, time, and place of printing; date of distribution, and the like. The logical record can have multiple subunits as previously discussed. When an input device contacts the look-up table, additional status data is received by the look-up table and can be recorded in the logical record. For example, the input device can communicate the date and time a logical record is accessed and prerecorded “credentials” for the input device, such as location, serial number, and the like. If desired, the receipt of the status data can be made a mandatory precursor to the updating of the logical record. The receipt of status data, updating, and reporting steps can be repeated for each time the logical record is accessed by an input device or by input devices and printing units. Status data in the logical records can be collected, maintained, cleared, and analyzed to determine if secure receivers 14 are diverted from distribution, arrive at their intended locations, and if the secure receivers at retail sites are verified to have the proper identity. Verification information can be provided to the verifier, or to the owner of the security customization system.

The invention has been described in detail with particular reference to certain preferred embodiments thereof, but it will be understood that variations and modifications can be effected within the spirit and scope of the invention.

1. A method for handling security customization data, said method comprising the steps of:
a. accessing a database having one or more logical records containing receiver specific security information comprising origination information and designation information by a user;
b. verifying said security information using a controller for said database of security information to access a logical record comprising receiver record data;
c. generating marking information comprising the security information;
d. transferring the marking information to the printer via said controller after verification;
e. printing the marking information comprising a verifiable security marking usable for security image identification on the receiver in a manner that is out of local control and under control of the owner using access codes to access said remote database; and
f. updating the logical record during steps c-e.

2. The method of claim 1 wherein the generating step further comprises enabling a printer to request the marking information for a receiver via the controller.

3. The method of claim 1 wherein the generating step further comprises digitally controlling changes to the logical unit during said generating, transferring and printing steps.

4. The method of claim 1 wherein the security marking is printed on an existing image already printed on said receiver.

5. The method of claim 1 wherein the security marking is combined with image stored locally on printer and printed as part of the modified image.

6. The method of claim 1 wherein the security instructions comprise an encryption key to unlock encryption on our system to make the marking information.

7. The method of claim 1 wherein the marking instructions is multi-part comprising marking instructions for each process step wherein said marking instructions are stored and separately readable at all steps of the process.

8. The method of claim 7 wherein said multi-part marking instructions for each process step is readable to only those with access to said encryption key such as the controlling party for that process step.

9. The method of claim 7 wherein verification further comprises a state of the receiver, such as which process step, and location [such as @manf, wholesale, retail, customs, and security check point)] at that point in process.

10. A system for printing security customization data, said system comprising:
a. controller to control access to a remote database comprising memory using an access code in conjunction with security information;
b. database memory for storing a logical record comprising one or more one or more receiver ID records comprising human readable data and encodeable security instructions comprising origination information and designation information accessible by a user using a verifiable code to access said logical record by verifying said encodeable information;
c. processor for generating marking information from stored marking information for printing said marking information; [Note that this could be generated by another controller such as in printer or another source such as a cell phone];
d. printer in communication with said database memory and processor for printing the marking information as a verifiable security marking usable for security image identification on the receiver after approval via controller;
e. communication network for transferring said marking information instructions from the remote database to the printer.

11. The system of claim 10 wherein the marking information is changed for each process step.

12. The apparatus of claim 11 further comprising subsequent marking information added in layers that do not visibly change the original marking information.

13. The system of claim 10 wherein the security marking is combined with a local image to be printed.

14. The system of claim 10 wherein the system further comprises an encryption key.

15. The system of claim 14 wherein said encryption key is used in conjunction to said marking information at process step so that the stored information is readable only by those with access to said encryption key, such as the controlling party for that process step.

16. A computer program product for handling security customization data, the computer program product comprising computer steps of:
a. generating a logical record corresponding to one or more receivers, said logical record including the state of the receiver data and security instructions comprising marking information instructions;
b. generating marking information comprising to the security instructions;
c. transferring the marking information to the printer;
d. remotely printing the marking information as a verifiable security marking usable for security image identification on the receiver in a manner that is out of local control;
e. controlling access to the logical record using the one or more access codes to download the marking information; and
f. updating the logical record during steps c-e.

17. A method for handling security customization data, said method comprising the steps of:
a. generating an access code to a remote database corresponding to owner;
b. accessing the remote database via a controller comprising security instructions including marking information instructions for a receiver using the access code;
c. transferring said marking information instructions from said remote database to the printer during printing;
d. initiating the receiver specific marking information instructions for a verifiable security marking (machine readable);
e. printing on the receiver the verifiable security marking; and
f. recording the printing-related events in the remote database.
